(19) United States
(12) Patent Application Publication
(10) Pub. No.: US 2016/0363103 A1
(43) Pub. Date: Dec. 15, 2016

(54) FUEL SUPPLY SYSTEM

(71) Applicant: NIKKI CO., LTD., Atsugi (JP)

(72) Inventors: Kazuki Kimura, Kanagawa-ken (JP); Yukinori Suematsu, Kanagawa-ken (JP); Teruyuki Wakabayashi, Kanagawa-ken (JP)

(21) Appl. No.: 15/172,144

(22) Filed: Jun. 2, 2016

(30) Foreign Application Priority Data
Jun. 11, 2015 (JP) 2015-118223

(51) Int. Cl. F02M 37/00; F02M 37/08

(52) U.S. Cl. CPC F02M 37/0017; F02M 37/0047; F02M 37/08

(57) ABSTRACT

A seal is fit between a cylindrical connector support which is protruded on an upper end face of a cylindrical barrel part of an electrically-powered high pressure pump embedded in a housing and from which a power connector is exposed and an inner peripheral surface of a hollow part formed in a top face of a lid body such that the seal is flush with a top face of the hollow part. A flange having an outer shape which is the same as an inner shape of the hollow part is protrudingly provided at a predetermined height position on a circumference of the connector support such that a lower surface of the flange is disposed flush with a top face of the hollow part.

### CROSS-REFERENCE TO RELATED APPLICATIONS

This application claims priority to Japanese Application No. JP2015-118223, filed Jun. 11, 2015, which is hereby incorporated by reference in its entirety.

### TECHNICAL FIELD

The present invention relates to a fuel supply system having a reservoir which is provided halfway on a fuel supply pipe connecting a fuel tank and an engine and is used to supply fuel stored in the fuel tank to the engine.

### BACKGROUND

When supplying liquid fuel stored in a fuel tank to an engine, it is conventionally necessary to continuously supply the fuel even if there is a rapid acceleration or a rapid deceleration, and it is also necessary to prevent evaporation of the fuel due to high temperatures in a fuel supply pipe generated by operation of the engine.

In view of the above, for example, U.S. Pat. No. 6,390,871 (JP 2013-516576 W) proposes an engine control module (fuel supply system) equipped with two pumps in a reserve tank. This engine control module (fuel supply system) is provided in the reserve tank with a first fuel pump as a draw-up pump for drawing up the fuel from a fuel tank to the reserve tank and a second fuel pump for feeding the fuel drawn-up into the reserve tank into a fuel rail of the engine at a higher pressure; thus, the engine control module has advantages also in saving pipes for a fuel pipe and in easy manufacturing.

In view of the above, the present inventors proposed an extremely high-efficient fuel supply system equipped with a reservoir (U.S. Ser. No. 14/293,595).

This fuel supply system equipped with a reservoir includes, as shown in FIGS. 1, 2, 5, and 6: a housing 1 on which a lid body 2 is fixed with plate-shaped spring clips 10, where the lid body 2 airtightly covers, via a seal, an opening 13 formed in a upper face of a housing main body 11 an upper face of which is opened and which has a bottom and forms a fuel storage tank 12 inside the housing main body 11; a high pressure pump 3 which discharges fuel stored in the fuel storage tank 12 disposed in the housing main body 11 from a fuel discharge pipe 21 formed on the lid body 2; and a low-pressure pump 4 which is integrally and detachably mounted on a wall surface 14 of the housing main body 11 and supplies the fuel from a fuel tank (not shown) into the fuel storage tank 12 of the housing main body 11 through a fuel pipe (not shown), where the low-pressure pump 4 is made up of, for example, a low-pressure diaphragm pulse pump.

Further, the high pressure pump 3 is pressingly held such that the high pressure pump 3 is fit in a mounting recess 61 of a holding member 6 which is formed of a resilient material such as synthetic rubber and has the flow passage 62 communicating with the fuel storage tank 12 and which is provided on a bottom of the housing main body 11 while a suction port 31 disposed on a lower end of a barrel part 34 embedded with an electrically-powered pump is opened to a flow passage 62. In another mounting recess 63 which is formed in the holding member 6 and communicates with the flow passage 62, a bullet type filter 7 is also provided while a feed-out port 71 is opened to the flow passage 62.

Further, inside the lid body 2 is provided a float 8 which determines a liquid surface position of fuel to be stored in the fuel storage tank 12. On the float 8, there is disposed a regulator 9 passing through the float 8, and the regulator 9 communicates with the fuel discharge pipe 21 connected to a discharge port 33 of the high pressure pump 3 disposed in the lid body 2 and the fuel storage tank 12.

In this conventional example, the fuel supply system is used, being fixed to an engine, a vehicle body, or the like (not shown) via a mounting part 18 protrudingly provided on the housing 1. The fuel drawn from a fuel tank (not shown) through the low-pressure pump 4 is drawn to the fuel storage tank 12 from an intake port 15 formed in the wall surface 14 of the housing main body 11 through a fuel passage 16 and a valve body 17 disposed inside the lid body 2, and the fuel is stored up to a predetermined liquid surface, being adjusted by the float 8. At the same time, the high pressure pump 3 having an electrically-powered pump operates to discharge the fuel in the fuel storage tank 12 from the fuel discharge pipe 21.

In this conventional example, the high pressure pump 3 has a cylindrical discharge port 33 on the upper end face 35 of the barrel part 34 and has the cylindrical connector support 32 from the tip part of which the power connector 321 is exposed, and the cylindrical discharge port 33 and the cylindrical connector support 32 are each projected. The upper part of the barrel part 34 is airtightly fit in and held by the lid body 2, via the seals 24 and 25 between the upper part of the barrel part 34 and the cylindrical barrel part connection piece 23 provided, downward in the vertical direction, on the top face 22 of the lid body 2, and the discharge port 33 is airtightly connected to the fuel discharge pipe 21 formed on the lid body 2 via the seal 26.

However, the connector support 32 is projected from the hollow part 27 formed in the lid body 2, and the power connector 321 is exposed outside the housing 1; thus, an external power source can be connected to the power connector 321 while the housing 1 is airtight.

Therefore, as shown in FIG. 6, the gap 28 is formed between the connector support 32, which is exposed in the hollow part 27 and is on the upper end face 35 of the barrel part 34 of the high pressure pump 3 and the hollow part 27; thus, moisture and dust can get in and stays in the gap 28 when used, whereby corrosion and seal defect can be created. When used on or near the sea, salt water affects more heavily. In particular, the airtightness relies on the seals 24 and 25 provided on the barrel part 34, and this arrangement is not enough.

### SUMMARY

An object of the present invention is to prevent the corrosion and seal leakage from occurring due to the gap formed between the connector support of the high pressure pump and the hollow part, where the high pressure pump is installed in the fuel supply system and is provided halfway on the fuel supply pipe to supply an engine with the liquid fuel stored in the conventional fuel tank.

To achieve the object described above, the present invention provides a fuel supply system, including: a housing, the housing including: a housing main body which forms a fuel storage tank which doubles as a reservoir, the housing main body having: an upper face having an opening; and a lid body which airtightly covers the opening in the upper face, the lid body having a fuel discharge pipe which have a pipe shape and is formed on a rear surface of the lid body, and the fuel supply system further including, in the housing: a high pressure pump configured to suction fuel stored in the fuel storage tank and to supply the fuel to an engine by discharging the fuel, the high pressure pump including: an electrically-powered pump embedded in the high pressure pump; and a cylindrical barrel part having a suction port in a part of the cylindrical barrel part; a cylindrical discharge port; and a cylindrical connector support, from a tip part of which a power connector is exposed, the cylindrical discharge port and the cylindrical connector support each projecting on an upper end face of the cylindrical barrel part, an upper part of the barrel part being airtightly fit in and held by the lid body, via a seal between the upper part of the barrel part and a cylindrical barrel part connection piece provided, downward in a vertical direction, on a top face of the lid body, the discharge port being airtightly connected to the fuel discharge pipe formed on the lid body, and the connector support being projected from a hollow part formed in the lid body, wherein the connector support is fit in an inner peripheral surface of the hollow part formed on the top face of the lid body, via a seal.

Further, in the present invention, it is further preferable when a flange having an outer shape which is the same as an inner shape of the hollow part is protrudingly provided at a predetermined height position on a circumference of the connector support such that the seal fit between the connector support and the inner peripheral surface of the hollow part is disposed flush with a top face of the hollow part and such that a lower surface of the flange is disposed flush with the top face of the hollow part of the lid body.

With the present invention, it is possible to prevent the corrosion and seal leakage from occurring due to the gap formed between the connector support of the high pressure pump and the hollow part, where the high pressure pump is installed in the fuel supply system and is provided halfway on the fuel supply pipe to supply an engine with the liquid fuel stored in the conventional fuel tank, and it is possible to improve airtightness of the whole housing.

### BRIEF DESCRIPTION OF DRAWINGS

FIG. 1 is an exploded perspective view of a preferable embodiment of the present invention and a conventional example;

FIG. 2 is a plan view showing a lid body and a high pressure pump in the embodiment of the present invention shown in FIG. 1;

FIG. 3 is a vertical cross sectional view in the embodiment of the present invention shown in FIG. 1;

FIG. 4 is an enlarged cross-sectional view showing a principal part in the embodiment of the present invention shown in FIG. 1;

FIG. 5 is a vertical cross sectional view of a conventional example; and

FIG. 6 is an enlarged cross-sectional view showing a principal part of a conventional example.

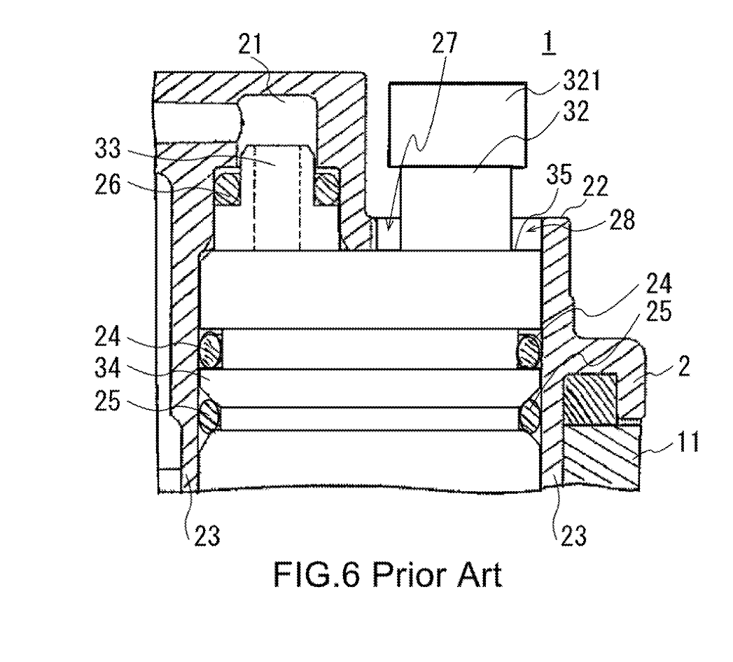

### DETAILED DESCRIPTION

In the following, a preferable example of the present invention will be described in detail with reference to the drawings.

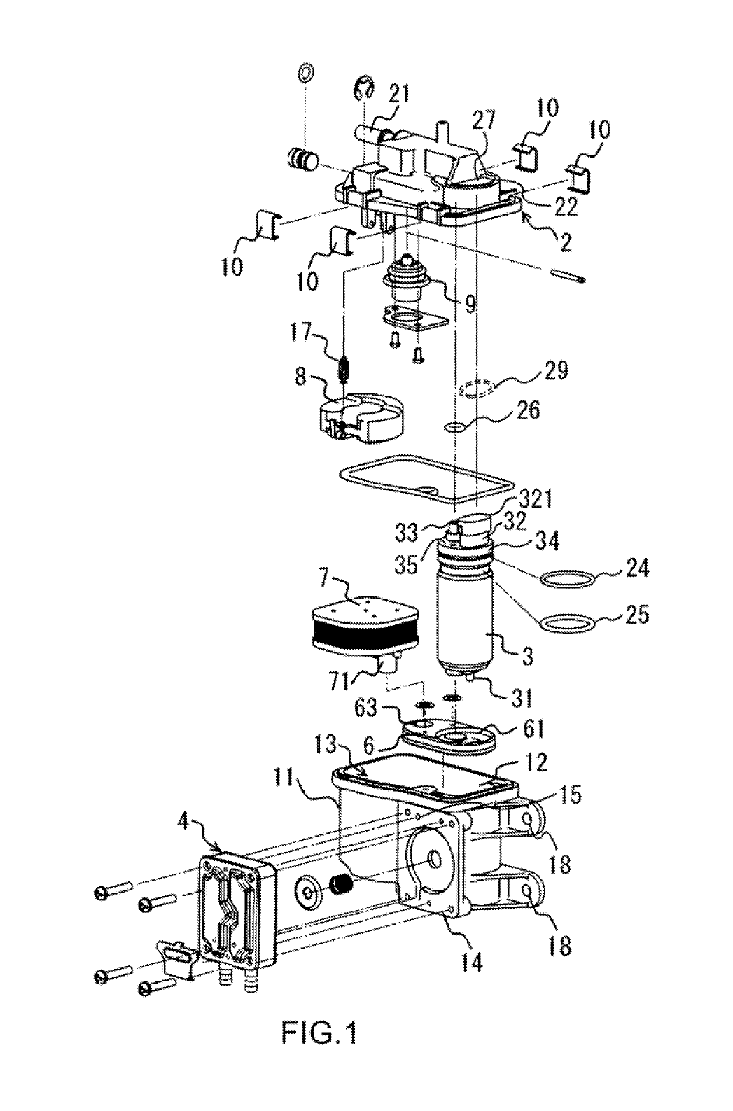

FIGS. 1 to 4 show a preferable embodiment of a fuel supply system of the present invention. A general configuration of the fuel supply system is almost the same as the configuration of a conventional example, and the general configuration is thus not described.

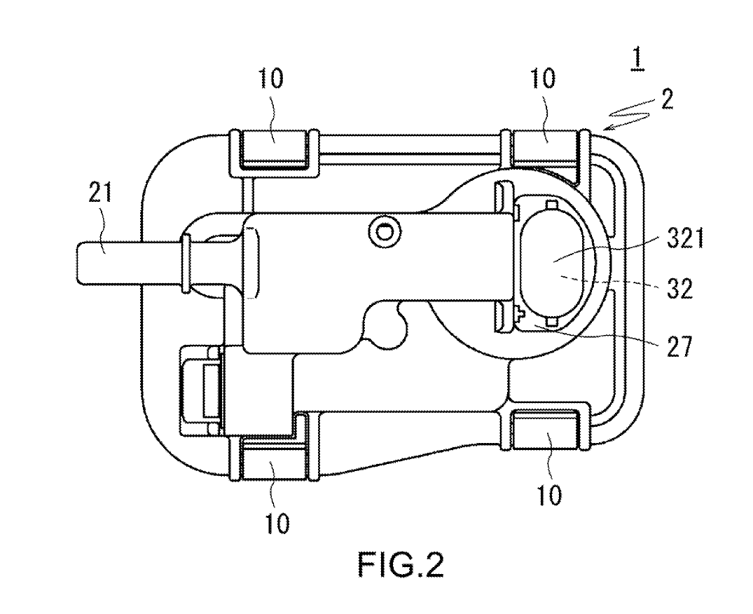

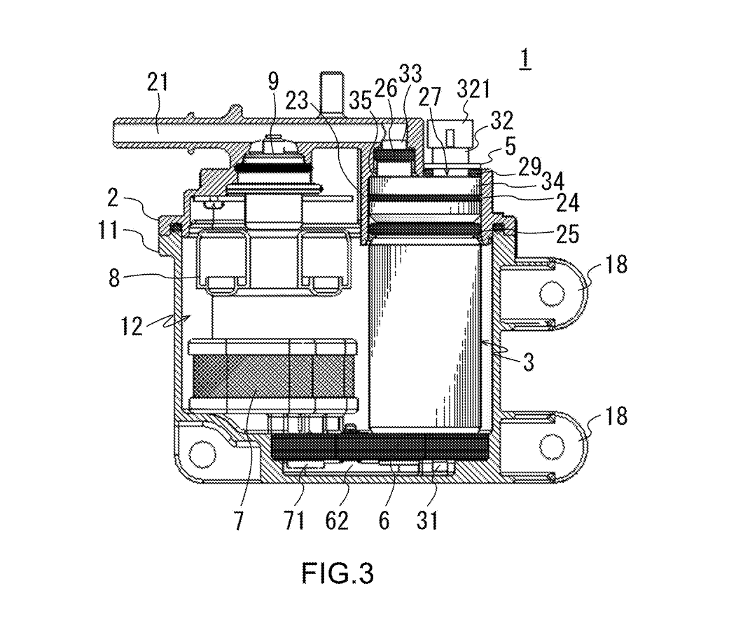

In a present exemplary embodiment, as shown in FIGS. 2 and 3, the high pressure pump 3 is embedded with an electrically-powered pump (not shown), and the high pressure pump 3 has a cylindrical discharge port 33 and a cylindrical connector support 32 from a tip part of which a power connector 321 is exposed. The cylindrical discharge port 33 and the cylindrical connector support 32 are each projected on an upper end face 35 of a cylindrical barrel part 34 having a suction port 31 in a part or the cylindrical barrel part 34. An upper part of the barrel part 34 is airtightly fit in and held by the lid body 2 via seals 24 and 25 between the upper part of the barrel part 34 and a cylindrical barrel part connection piece 23 provided, downward and in the vertical direction, on a top face 22 of the lid body 2. The discharge port 33 is airtightly connected to a fuel discharge pipe 21 formed on the lid body 2 via a seal 26. The connector support 32 is projected from a hollow part 27 formed in the lid body 2. The connector support 32 is fit in a gap 28 formed on an inner peripheral surface of the hollow part 27 formed on the top face 22 of the lid body 2, via a seal 29.

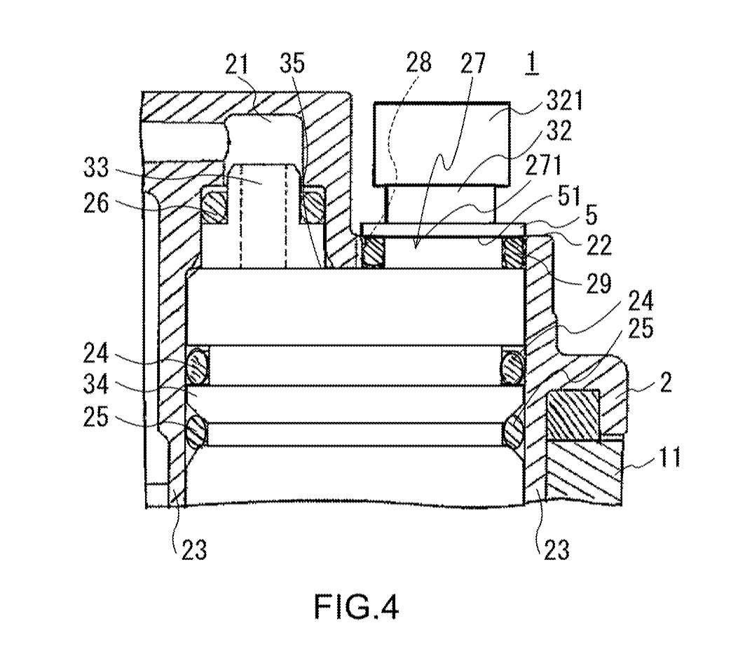

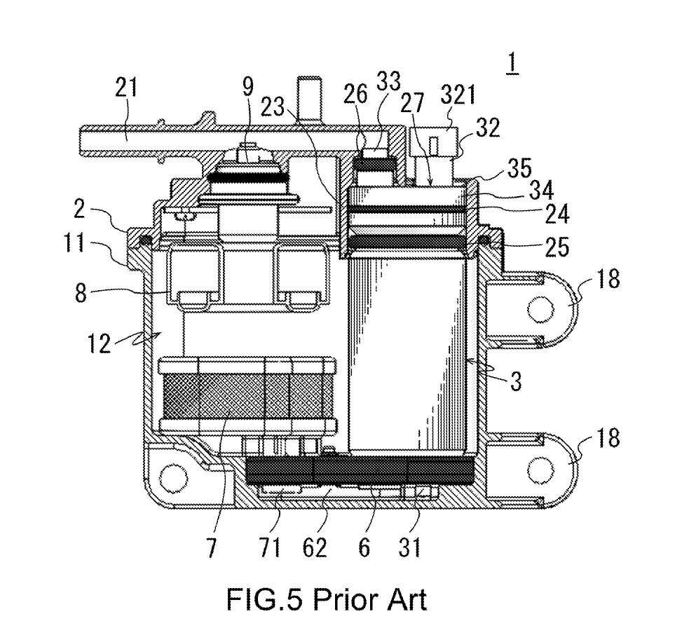

Therefore, since, unlike the conventional example shown in FIGS. 4 and 5, a gap 28 is not formed between the hollow part 27 and the connector support 32 in the present exemplary embodiment, neither corrosion nor seal leakage occurs due to moisture and dust accumulated in the gap 28. In particular, an airtight state is established also at the part of connector support 32 by the seals 24 and 25 and the seal 29 provided on the barrel part 34; therefore, seal leakage on this part can be surely prevented.

Further, in the present exemplary embodiment, a flange 5 having an outer shape which is the same as an inner shape of the hollow part 27 is protrudingly provided at a predetermined height position on a circumference of the connector support 32 such that the seal 29 fit between the connector support 32 and the inner peripheral surface of the hollow part 27 is disposed flush with a top face 271 of the hollow part 27 and such that a lower surface 51 of the flange 5 is disposed flush with the top face 271 of the hollow part 27 of the lid body 2.

Therefore, the flange 5 is configured to cover the seal 29 and thus to prevent water from directly splashing the seal 29, whereby water resistance and corrosion resistance can be further improved by virtue of the waterproof property.

Note that, as the seal used in each place in the present exemplary embodiment, it is possible to use, for example, a conventionally-known O-ring, which is made of silicone rubber and has a relatively low hardness, or the like, and such an O-ring is preferable from the point of view of assembly.

1. A fuel supply system, comprising:
a housing, the housing including:
a housing main body which forms a fuel storage tank which doubles as a reservoir, the housing main body having an upper face having an opening; and
a lid body which airtightly covers the opening in the upper face, the lid body having a fuel discharge pipe which have a pipe shape and is formed on a rear surface of the lid body, and
the fuel supply system further comprising, in the housing:
a high pressure pump configured to suction fuel stored in the fuel storage tank and to supply the fuel to an engine by discharging the fuel, the high pressure pump including:
an electrically-powered pump embedded in the high pressure pump; and
a cylindrical barrel part having a suction port in a part of the cylindrical barrel part;
a cylindrical discharge port; and
a cylindrical connector support, from a tip part of which a power connector is exposed, the cylindrical discharge port and the cylindrical connector support each projecting on an upper end face of the cylindrical barrel part,
an upper part of the barrel part being airtightly fit in and held by the lid body, via a seal between the upper part of the barrel part and a cylindrical barrel part connection piece provided, downward in a vertical direction, on a top face of the lid body,
the discharge port being airtightly connected to the fuel discharge pipe formed on the lid body, and
the connector support being projected from a hollow part formed in the lid body,
wherein the connector support is fit in an inner peripheral surface of the hollow part formed on the top face of the lid body, via a seal.

2. The fuel supply system according to claim 1, wherein a flange having an outer shape which is the same as an inner shape of the hollow part is protrudingly provided at a predetermined height position on a circumference of the connector support such that [[the]] a seal fit between the connector support and the inner peripheral surface of the hollow part is disposed flush with a top face of the hollow part and such that a lower surface of the flange is disposed flush with the top face of the hollow part of the lid body.

3. A fuel supply system, comprising:
a housing main body which forms a fuel storage tank which doubles as a reservoir, the housing main body having an upper face having an opening;
a lid body which airtightly covers the opening in the upper face, the lid body having a fuel discharge pipe which have a pipe shape and is formed on a rear surface of the lid body; and
a high pressure pump configured to suction fuel stored in the fuel storage tank and to supply the fuel to an engine by discharging the fuel.

4. The fuel supply system of claim 3, wherein the high pressure pump further includes:
an electrically-powered pump embedded in the high pressure pump; and
a cylindrical barrel part having a suction port in a part of the cylindrical barrel part;
a cylindrical discharge port; and
a cylindrical connector support.

5. The fuel supply system of claim 4, wherein the cylindrical connector support is from a tip part of which a power connector is exposed.

6. The fuel supply system of claim 4, wherein the cylindrical discharge port and the cylindrical connector support each project from an upper end face of the cylindrical barrel part.

7. The fuel supply system of claim 4, wherein an upper part of the barrel part airtightly fits in and is held by the lid body, via a seal

8. The fuel supply system of claim 7, wherein the seal is between the upper part of the barrel part and a cylindrical barrel part connection piece provided, downward in a vertical direction, on a top face of the lid body.

9. The fuel supply system of claim 4, wherein the discharge port is airtightly connected to the fuel discharge pipe formed on the lid body.

10. The fuel supply system of claim 4 wherein the connector support is projected from a hollow part formed in the lid body.

11. The fuel supply system of claim 4, wherein the connector support fits in an inner peripheral surface of the hollow part formed on the top face of the lid body, via a seal.

12. The fuel supply system of claim 4, wherein a flange having an outer shape which is the same as an inner shape of the hollow part is protrudingly provided at a predetermined height position on a circumference of the connector support such that a seal fit between the connector support and the inner peripheral surface of the hollow part is disposed flush with a top face of the hollow part and such that a lower surface of the flange is disposed flush with the top face of the hollow part of the lid body.

13. A fuel supply system comprising:
a high pressure pump configured to suction fuel stored in the fuel storage tank and to supply the fuel to an engine by discharging the fuel, the high pressure pump including:
an electrically-powered pump embedded in the high pressure pump; and
a cylindrical barrel part having a suction port in a part of the cylindrical barrel part;
a cylindrical discharge port; and
a cylindrical connector support.

14. The fuel supply system of claim 13, wherein the cylindrical connector support is from a tip part of which a power connector is exposed.

15. The fuel supply system of claim 13, wherein the cylindrical discharge port and the cylindrical connector support each project from an upper end face of the cylindrical barrel part.

16. The fuel supply system of claim 13, wherein an upper part of the barrel part airtightly fits in and is held by a lid body, via a seal.

17. The fuel supply system of claim 16, wherein the seal is between the upper part of the barrel part and a cylindrical barrel part connection piece provided, downward in a vertical direction, on a top face of the lid body.

18. The fuel supply system of claim 13, wherein the discharge port is airtightly connected to a fuel discharge pipe formed on a lid body.

19. The fuel supply system of claim 13, wherein the connector support is projected from a hollow part formed in a lid body.

20. The fuel supply system of claim 13, wherein the connector support fits in an inner peripheral surface of a hollow part formed on a top face of the lid body, via a seal.
